(19) United States
(12) Patent Application Publication
(10) Pub. No.: US 2004/0171287 A1
(43) Pub. Date: Sep. 2, 2004

(54) Contact element

(76) Inventor: Vasilios Spiropoulos, Lund (SE)

Correspondence Address: Gregory P LaPointe, Bachman & LaPointe, Suite 1201, 900 Chapel Street, New Haven, CT, 06510, US

(21) Appl. No.: 10/483,472

(22) PCT Filed: Jul. 8, 2002
(86) PCT No.: PCT/SE02/01357

(30) Foreign Application Priority Data
Jul. 12, 2001 (SE) 0102491-8

(51) Int. Cl. H01R 4/58

(52) U.S. Cl. 439/86

(57) ABSTRACT

A contact element for electric components (1) is manufactured from a conductive material. The material is moreover rubber-like elastic and deformable. As a result, contact forces are realised between the contact element (4) and the electronic components (1) which are to be interconnected. An electric contact comprises a first and a second metal part which are to be interconnected electrically. Moreover, the contact includes a contact element which is resilient. The contact element is produced from an electrically conductive silicon material.

### TECHNICAL FIELD

The present invention relates to a contact element for electronic components, being manufactured from a conductive material.

The present invention also relates to an electric contact comprising a first and second metal part which are to be interconnected electrically, as well as an electrically conductive and resilient contact element interconnecting them.

### BACKGROUND ART

Within the electronics industry, for example in the manufacture of cell or mobile telephones, development is constantly moving towards smaller units, i.e. mobile telephones, and consequently smaller components. At the same time, demands are also placed on high performance and operational reliability. This entails that a large number of components are included in the finished products and that these components are interconnected directly or indirectly to one another. Problems arising out of shortage of space are becoming increasingly manifest.

Operational reliability is directly linked to the working of the interconnection, i.e. that electric contact is maintained at a large number of points, in particular on the transfer of signals such as antenna signals. In these points, contact elements are disposed which are in electric and mechanical communication with a contact site, for example a circuit card. Such a contact site is occasionally also called a “pad”.

In order to ensure contact between the contact element and the contact site or pad, the contact element is often designed as a metal spring. The metal in the spring possesses the necessary electric conductive capacity, while its resilience realises a certain pressure against the contact site.

One drawback inherent in this technique is that there is a risk that the contact between the contact element and the contact site will be poor for various reasons. One such reason may be that the spring is bent in an unsuitable manner, and that, as a result, it does not abut sufficiently against the contact surface. Another reason for poor contact is that the metals, on the one hand in the contact element and, on the other hand in the contact surface, oxidise when they come into contact with the oxygen of the air, and that these oxides suffer from poor conductive capacity. In order to solve the latter problem, use is occasionally made of gold plating (often in combination with nickel) of the contact element and the contact site. Since gold is a noble metal no oxide layer is formed thereon, but a superior conductive capacity is maintained over lengthy periods of time. The drawback inherent in gold plating is the cost involved, partly for the raw material and partly for an extra working phase in production.

A further drawback inherent in gold plating is that the plated layer is thin and, as a result, sensitive to mechanical wear which occurs on contact with contact elements of metal.

Further, use is also made of contact elements in the form of resilient telescopic rods, so-called pogo pins, which in principle consist of two tubes with an inner spring. These are expensive in manufacture and assembly and moreover require that the contact site be plated, in addition to the fact that the pogo pin itself is also plated. A further drawback is that these are often relatively long in the vertical direction, often as much as between 3 and 4 mm.

### PROBLEM STRUCTURE

The present invention therefore has for its object to realise a contact element which mechanically abuts distinctly against the elements which are to be interconnected, at the same time as the problems inherent in oxidation of metals are obviated without the need to use gold for the plating.

### SOLUTION

The object forming the basis of the present invention will be attained if the contact element intimated by way of introduction is characterised in that the material is moreover rubber-like elastic and deformable in order to achieve contact forces between the contact element and the electronic components which are to be interconnected.

Further advantages will be attained if the contact element is also given one or more of the characterising features as set forth in appended claims 2 to 7.

Concerning the electric contact, the objects of the present invention will be attained if this is characterised in that the contact element is produced from an electrically conductive silicon material.

Further advantages will be attained if the electric contact is moreover given one or more of the characterising features as set forth in appended claims 9 and 10.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a perspective view of an antenna with contact elements according to the present invention;

FIG. 2 is an exploded view of the antenna of FIG. 1;

FIG. 3 is a perspective view of an open electric contact according to the present invention; and

FIG. 4 is a straight side elevation of the contact of FIG. 3 in the closed state.

### DESCRIPTION OF PREFERRED EMBODIMENT

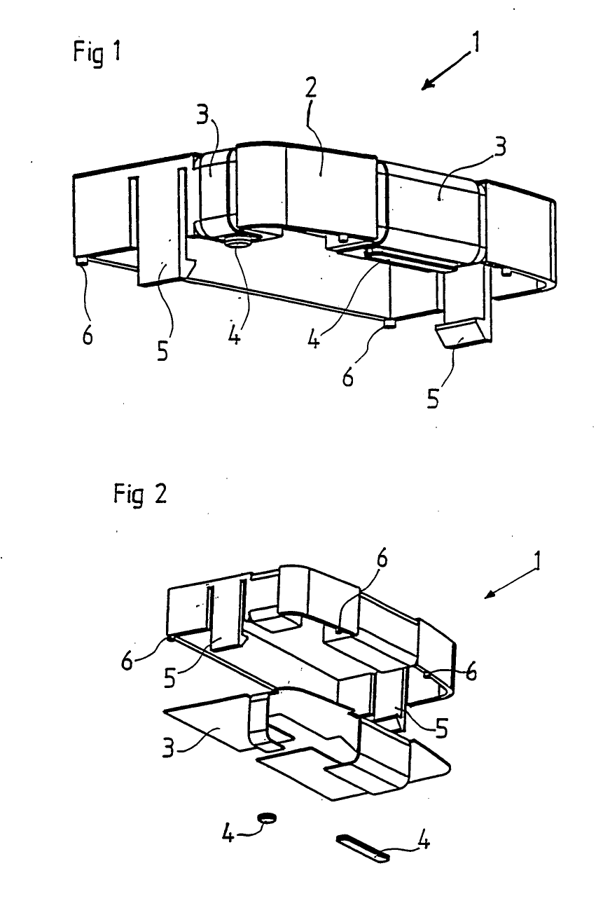

FIG. 1 shows one example of an electronic component which is provided with contact elements according to the present invention. The electronic component consists in this case of an antenna 1 which includes a carrier 2, a radiator element 3 and contact elements 4. The antenna is intended to be employed for transmitting and receiving at high frequencies, i.e. in the range of from 800 MHz and upwards. At present, frequencies of up to about 2.5 GHz are used, but frequencies of at least 5-6 GHz are also conceivable.

The carrier 2 consists of a configurationally stable material such as a plastic, and is further provided with snap catches 5 for a mechanical fixing of the carrier 2 to a substrate, for example a circuit card. The carrier 2 further has a number of spacers 6 which keep the major portion of the carrier at a given, predetermined distance from the substrate.

The radiator element 3 is disposed on or in the carrier 2 and may have a multiplicity of different configurations. The configuration which is shown in the Drawings is but one of many examples. The radiator element 3 is manufactured from a conductive material, for example a metal, even though other materials are also conceivable. One or more portions of the radiator element 3 are bent around the sides of the carrier 2 and in their turn constitute a substrate for the contact elements 4. The radiator element 3 emits signals which constantly vary. It is important that the signals are not warped or distorted in any way, e.g. because of poor contact, since the message which the signals transmit would then be lost.

In order to save space on the circuit card, it is normal to attempt to dispose the antenna or at least its radiating element a distance away from the circuit card and its components, with contact prevailing only at individual points. In the preferred embodiment, it is possible to dispose electronic components below and within the carrier, since the antenna is in contact with the substrates only at a few points. Compact solutions and greater freedom in design and construction are thus made possible. It is also possible to create contacts in very narrow spaces, not least since the extent in the vertical direction is slight, of the order of magnitude of approx. 1 mm.

FIG. 2 shows an exploded diagram of the antenna 1 according o FIG. 1. In this view, the radiator element 3 is more clearly visible than in FIG. 1. The contact elements 4 are also apparent with somewhat greater clarity.

In the preferred embodiment, the contact elements 4 are two in number. The one contact element is elongate for realising a linear abutment against the contact surface of a circuit card, while the other contact element has the outer contour of a small circle for realising a substantially punctiform abutment.

The contact elements 4 are manufactured from a conductive, elastic rubber-like material. In the preferred embodiment, they are manufactured from a conductive silicon material. The silicon material has been rendered conductive by the addition of a quantity of conductive particles which, however, do not affect the mechanical properties of the silicon to any appreciable degree. One major advantage inherent in the silicon material is that it will have no oxide layer on its surface, even in lengthy contact with the oxygen of the air.

The silicon is applicable in various conceivable patterns and configurations on the radiator element 3. The silicon may also be applied in various way, for example with the aid of injection moulding, extrusion or by means of templates. Once the silicon material has been applied, it is generally heat treated for curing, setting and a permanent adhesion to the substrate, i.e. the radiator element 3. In such instance, air is expelled and the metal surface of the substrate beneath the silicon is protected from air and corrosion as a result of the adhesion of the silicon.

In the preferred embodiment, the contact elements 4 display a certain extent in the vertical direction. It should be observed that this extent is slightly greater than the height of the spacers 6 so that, on assembly, a certain compression takes place. When the antenna 1 is snapped in place with the aid of the snap catches 5 of the carrier 2, the contact elements 4 will be clamped in position, i.e. be subjected to a mechanical compressive force. In such instance, it will be ensured that the contact element 4 is in good contact with the substrate. Because of the elasticity of the silicon material, this strives to reassume its original form and the contact forces in the contact sites will therefore, be retained throughout the entire service life of the component. At the same time as the elasticity of the material realises the mechanical contact forces when the contact elements 4 are compressed, the compression will also entail an extremely tight contact between the contact elements 4 and the substrate. This entails that oxygen will not gain access to the metals in the contact points, where the contact elements abut, and so no oxide layer can occur. By such means, a superior conductive capacity will be maintained in the contact points and the antenna signals will be conducted through the contact points without difficulty.

The material properties of the silicon material also give a contact element 4 which, on the one hand, is in abutment with a certain surface extent and, on the other hand, has no sharp edges. In addition, the material is in principle immobile in the contact surfaces against the substrate, which taken together eliminates the risk of wear on the contact sites.

By the provision of the spacers 6, it is simpler to place other components beneath the carrier 2, since leads to them are easy to place in the interspace which occurs between the substrate and the carrier 2.

Thus, the contact elements 4 according to the present invention realise both the necessary contact pressure and the conductive capacity required in the contacts. Moreover, oxidation of the contact sites is prevented and conductive capacity is thereby maintained.

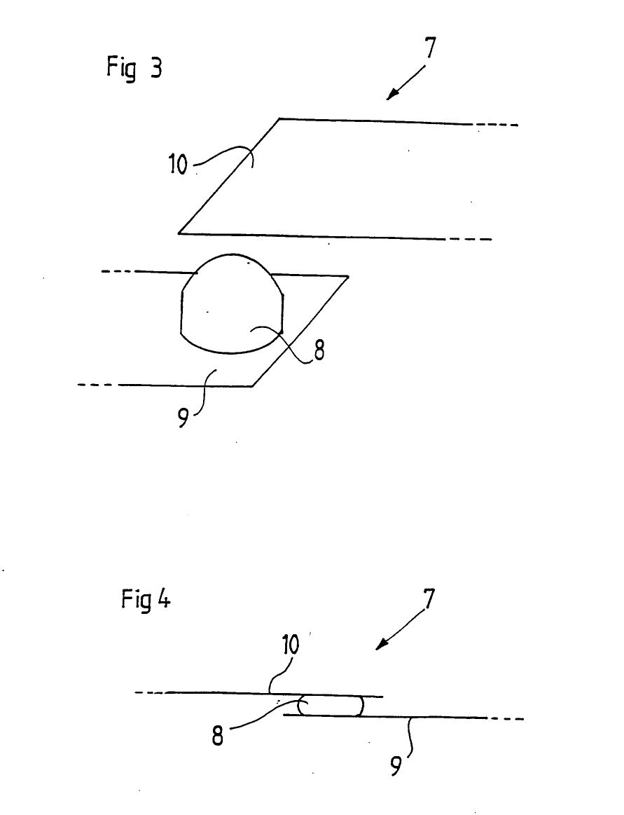

FIG. 3 shows a generalised electric contact 7 in the open position. The electric contact has one contact element 8. The contact element 8 is applied on a conductive substrate, preferably in the form of a first metal part 9, even though other conductive materials are conceivable. The electric contact 7 further comprises a second metal part 10 which is provided and intended for contact with the contact element 8 when the electric contact 7 is closed or “made”. The contact elements 8 have a certain height extent in the open position.

When the electric contact 7 is closed, as shown in FIG. 4, the mechanical forces which hold it in the closed position will also indirectly compress the contact element 8. The contact element 8 will substantially maintain its volume, but its form will be changed until the contact 7 is once again opened. The form change entails substantially that the contact element 8 is flattened out and its sides bulge outwards. The change in form entails that air is expelled and that portions of the metal parts 9 and 10 are protected from corrosion, since access by oxygen to these portions is prevented by the surface abutment of the silicon material.

### DESCRIPTION OF ALTERNATIVE EMBODIMENTS

The above-described type of contact element according to the present invention may be varied in different ways, in particulars regarding its configuration. Many different forms are conceivable depending upon the purpose of the contacts. A few examples are contact elements 4 with linear abutment and punctiform abutment, but also contact elements 4 in the form of rings or meanders are conceivable. In principle, the configuration of the contact element is optional, since it is variable within broad limits.

In the preferred embodiment, the contact element is shown as disposed on a metal. The conductive material which is employed as substrate need not, however, be metallic. Other materials are, for example, metal-plated plastics and flexi-film with a copper foil. The material may actually also be the same material which is used in the contact element. It is also conceivable that the conductor in the substrate and the contact element are of one piece manufacture with each other.

In the preferred embodiment, the contact elements 4 are shown when they are disposed on a component 1. It is also conceivable that corresponding contact elements 4 may be disposed on a circuit card on its manufacture and that the components are connected to the contact elements on the circuit card. In such instance, it may, for example, be possible to connect a plurality of components to the same potential with the aid of one elongate contact element.

The present invention may be modified further without departing from the scope of the appended claims.

What is claimed is:

1. A contact element for electronic components (1), manufactured from a conductive material, characterised in that the material is moreover rubber-like elastic and deformable for realising contact forces between the contact element (4) and the electronic components (1) which are to be interconnected.

2. The contact element as claimed in claim 1, characterised in that the contact element (4) is connected to a substrate (3) of metal by its adhesion.

3. The contact element as claimed in claim 1, characterised in that it is of one piece manufacture with an electric conductor.

4. The contact element as claimed in any of claims 1 to 3, characterised in that the contact element is formable and elastic such that the site against which abutment takes place is protected from access by the air and consequential oxidation.

5. The contact element as claimed in any of claims 1 to 4, characterised in that its geometric configuration is arranged for punctiform abutment against a substrate.

6. The contact element as claimed in any of claims 1 to 4, characterised in that its geometric configuration is arranged for linear abutment against a substrate.

7. The contact element as claimed in any of claims 1 to 6, characterised in that the material is a silicon material.

8. An electric contact comprising a fist and a second metal part (9, 10), which are to be electrically interconnected, as well as an electrically conductive and resilient element (8) interconnecting them, characterised in that the contact element is produced from an electrically conductive silicon material.

9. The electric contact as claimed in claim 8, characterised in that the contact element (8) is secured on the first metal part (9) by means of the inherent adhesive capacity of the silicon material.

10. The electric contact as claimed in claim 8 or 9, characterised in that the contact element (8) is in air-expelling abutment against the second metal part (10).

11. Use of an electrically conductive silicon material possessing superior adhesion against a metal surface for producing an electric contact element.
